(19) United States
(12) Patent Application Publication
(10) Pub. No.: US 2023/0271163 A1
(43) Pub. Date: Aug. 31, 2023

(54) PROCESS FOR CATALYTIC CRACKING AND EQUILIBRIUM FCC CATALYST

(71) Applicant: W. R. Grace & Co.-Conn., Columbia, MD (US)

(72) Inventors: Shankhamala Kundu, Rockville, MD (US); Ruizhong Hu, Rockville, MD (US); Wu-Cheng Cheng, Ellicott City, MD (US); Michael Ziebarth, Columbia, MD (US)

(73) Assignee: W. R. Grace & Co.-Conn., Columbia, MD (US)

(21) Appl. No.: 18/016,099

(22) PCT Filed: Jul. 7, 2021
(86) PCT No.: PCT/US2021/040746

§ 371 Date: Jan. 13, 2023

Related U.S. Application Data
(60) Provisional application No. 63/051,551, filed on Jul. 14, 2020.

(51) Int. Cl. B01J 23/02; B01J 29/08; B01J 35/00; B01J 35/02; C10G 29/16

(52) U.S. Cl. CPC B01J 23/02; B01J 29/084; B01J 35/006; B01J 35/0013; B01J 35/026; C10G 29/16; C10G 2300/205

(57) ABSTRACT

A process for catalytic cracking of an iron-contaminated fluid catalytic cracking (FCC) feedstock. The process may include combining a FCC catalyst, a slurry containing a magnesium compound, and an iron-contaminated FCC feedstock during a FCC process under fluid catalytic cracking conditions, thereby generating an equilibrium FCC catalyst with reduced iron poisoning. The slurry containing the magnesium compound may not contain a calcium compound.

### FIELD OF THE INVENTION

The present invention relates to a process for catalytic cracking, and more particularly, to a process for catalytic cracking of an iron-contaminated fluid catalytic cracking (FCC) feedstock and an equilibrium FCC catalyst generated thereof.

### BACKGROUND

The fluid catalytic cracking (FCC) process is a very important refinery processes. During the FCC process, a catalyst is exposed to different deactivation mechanisms such as hydrothermal and thermal deactivation and poisoning by feedstock contaminants such as alkali and alkaline earth metals, nickel, vanadium and iron. Iron poisoning has gained much attention in recent years as the iron poisoning is observed more often due to decreasing average feedstock quality over the years. It is known that Fe brought in by a contaminated FCC feedstock can be deposited on the FCC catalyst and form a dense layer on an outer surface of the catalyst particles. The dense layer reduces diffusion of feed molecules going in and cracked molecules coming out of the catalyst particles, thereby negatively impacting activity and selectivity of the FCC catalyst. This phenomenon is often referred as iron poisoning of the FCC catalyst. The iron poisoning of the FCC catalyst can result in operational issues as well as deterioration of activity and selectivity of the catalyst.

U.S. Pat. No. 8,372,269 discloses a method of metal passivation on during fluid catalytic cracking (FCC). The method includes contacting a metal-containing hydrocarbon fluid stream in an FCC unit comprising a mixture of a fluid catalytic cracking catalyst and a particulate metal trap. The particulate metal trap includes a spray dried mixture of kaolin, magnesium oxide or magnesium hydroxide, and calcium carbonate.

U.S. Pat. No. 6,723,228 discloses an additive used in catalytic cracking of hydrocarbons, which is in the form of homogeneous liquid and comprises a composite metal compound. The composite metal compound consists of the oxides, hydroxides, organic acid salts, inorganic acid salts or metal organic complex compounds of at least one of the 1^{st} group metals and at least one of the 2nd group metals. The 1^{st} group metals are selected from the group consisting of the metals of the IIIA, IVA, VA, VIA groups of the Element Period Table. The 2nd group metals are selected from the group consisting of alkali-earth metals, transition metals, and rare earth metals. The additive can passivate metals and promote the oxidation of CO, and is operated easily with production cost decreased.

U.S. Pat. No. 7,361,264B2 discloses a method of increasing the performance of a fluid catalytic cracking (FCC) catalyst in the presence of at least one metal. The method includes contacting a fluid stream from an FCC unit comprising the fluid catalytic cracking catalyst with a compound comprising magnesium and aluminum, and having an X-ray diffraction pattern displaying at least a reflection at a 2-theta peak position at about 43 degrees and about 62 degrees, and wherein the compound has not been derived from a hydrotalcite compound.

International patent publication No. WO 2015/051266 discloses a process for reactivating an iron-contaminated FCC catalyst. The process comprises contacting the iron-contaminated FCC catalyst with an iron transfer agent. The iron transfer agent comprises a magnesia-alumina hydrotalcite material that contains a modifier selected from the group consisting of calcium, manganese, lanthanum, iron, zinc, or phosphate.

### BRIEF SUMMARY

One example of the present invention is a process for catalytic cracking of an iron-contaminated FCC feedstock. The process may include combining a FCC catalyst, a slurry comprising a magnesium compound, and an iron-contaminated FCC feedstock during a FCC process under fluid catalytic cracking conditions, thereby generating an equilibrium FCC catalyst with reduced iron poisoning. The slurry comprising the magnesium compound may not contain a calcium compound. Unexpectedly, addition of a small amount of the magnesium compound in absence of the calcium compound onto an iron-contaminated FCC catalyst effectively increases diffusivity of hydrocarbons into and out of the FCC catalyst, thereby preserving activity and selectivity of the FCC catalyst. As a result, the iron poisoning of the FCC catalyst by the iron-contaminated FCC feedstock is reduced significantly during the FCC process.

Another example of the present invention is an equilibrium FCC catalyst. The equilibrium FCC catalyst may include an FCC catalyst. The FCC catalyst may contain calcium, and have at least one magnesium compound and iron compounds deposited on the FCC catalyst. A weight ratio of the magnesium compound, as MgO, to the iron compounds, as Fe, on the equilibrium FCC catalyst may be greater than about 0.1. A weight ratio of calcium compounds to the magnesium compound on the FCC catalyst, reported as CaO/MgO, may be less than about 0.25.

### BRIEF DESCRIPTION OF THE DRAWINGS

The subject matter which is regarded as the disclosure is particularly pointed out and distinctly claimed in the claims at the conclusion of the specification. The foregoing and other objects, features, and advantages of the present disclosure are apparent from the following detailed description taken in conjunction with the accompanying drawings in which:

FIG. 1 shows electron probe micro-analyzer (EPMA) analysis of nanoparticles of iron compounds deposited on a FCC catalyst in the related art;

FIG. 2A shows electron probe micro-analyzer (EPMA) analysis of nanoparticles of iron compounds deposited on a FCC catalyst according to one embodiment of the present disclosure; and

FIG. 2B shows electron probe micro-analyzer (EPMA) analysis of nanoparticles of a magnesium compound deposited on a FCC catalyst according to one embodiment of the present disclosure.

### DETAILED DESCRIPTION

The present disclosure will be further described in detail with reference to the accompanying drawings. When referring to the figures, like structures and elements shown throughout are indicated with like reference numerals. Obviously, the described embodiments are only a part of the embodiments of the present disclosure, not all of the embodiments. All other embodiments obtained by a person of ordinary skill in the art based on the embodiments of the present disclosure without creative efforts are within the protection scope of the present disclosure. In the description of the following embodiments, specific features, structures, materials or characteristics may be combined in any suitable manner in any one or more embodiments or examples.

A number modified by “about” herein means that the number can vary by 10% thereof. A numerical range modified by “about” herein means that the upper and lower limits of the numerical range can vary by 10% thereof.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise.

The following terms, used in the present description and the appended claims, have the following definition.

An equilibrium FCC catalyst or “Ecat” is a catalyst in the inventory of the FCC unit that has been deactivated due to repeated cracking of hydrocarbon feedstock and regeneration to burn off the coke. A fresh fluid cracking catalyst is a catalyst as manufactured and sold by catalyst vendors. As the catalyst ages, it undergoes changes due to attrition, accumulation of feedstock metals and exposure to the severe hydrothermal environment of the FCC unit. The aged catalyst is characterized by loss of surface area and acid sites, which result in deterioration of activity and selectivity. During the FCC process, fresh catalyst is added, and aged catalyst is withdrawn, as needed, to maintain catalytic activity and selectivity as well as to hold proper catalyst bed levels in the FCC reactor and regenerator vessels. The equilibrium catalyst is a catalyst in the circulating inventory that reflects a balance between rates of catalyst deactivation and replacement. Hence, the Ecat includes an age distribution of fresh to severely deactivated FCC catalyst particles.

One example of the present invention is a process for catalytic cracking of an iron-contaminated fluid catalytic cracking (FCC) feedstock. The process may include combining a FCC catalyst from the circulating inventory of the FCC unit, a slurry containing a magnesium compound, and an iron-contaminated FCC feedstock during a FCC process under fluid catalytic cracking conditions, thereby generating an improved equilibrium FCC catalyst with reduced iron poisoning. The slurry containing the magnesium compound may not contain a calcium compound.

The FCC catalyst may be in a form of particles having an average diameter in a range of about 50 μm to about 110 μm, and contain about 10-60% zeolite crystals. The zeolite may be the primary catalytic component for selective cracking reactions. In one embodiment, the zeolite is a synthetic faujasite crystalline material. It includes material that is manufactured in the sodium form (Standard-Y) by crystallization of compositions containing silica and alumina, under alkaline conditions, followed by washing to lower the sodium; and ultrastable Y (“USY”), produced by increasing the silicon/aluminum atomic ratio of the parent standard-Y zeolite via a dealumination process. The resulting USY zeolite is much more stable to the hydrothermal deactivation in commercial FCC units than Standard Y zeolite. The Standard-Y and USY zeolites can be treated with cations, typically rare earth mixtures, to remove sodium from the zeolite framework to form REY, CREY and REUSY, which may increase activity and further stabilize the zeolite to deactivation in the FCC unit. The zeolite may possess pores in the 7.4-12 Å range. Surface area of the equilibrium FCC catalyst corresponding to the zeolite, i.e., surface area corresponding to pores in the range of <20 Å, typically ranges from 20 to 300 m²/g, preferably from 40 to 200 m²/g, as determined by the t-plot method. The Y zeolites described above can also be made by crystallization of microspheres comprising calcined kaolin, as described in U.S. Pat. Nos. 6,656,347, 6,942,784, and 5,395,809.

In the FCC catalyst, other than the zeolite, the catalyst contains a matrix. The FCC matrix may include a porous, catalytically active alumina or silica alumina for improving cracking of the heavier molecules in the feedstock, so-called bottoms cracking.

The FCC matrix may also include a specialty alumina for passivating nickel and traps for passivating vanadium. One example of a nickel-passivating alumina is an alumina derived from crystalline boehmite, which may be incorporated in the fresh catalyst at the 3 to 30 wt % range, reported as Al₂O₃. One example of a vanadium trap is a rare earth compound, which may be incorporated in the fresh catalyst at the range of 1 to 10 wt %, reported as RE₂O₃.

The FCC matrix may further contain clay. While not generally contributing to the catalytic activity, clay may provide mechanical strength and density to the overall catalyst particle to enhance its fluidization.

Finally, the FCC matrix may further contain a binder. This is the glue that holds the zeolite, active alumina, metals traps, and clay together. The binders may be typically silica-based, alumina-based, silica-alumina based or clay-based.

The FCC matrix contributes to pores in the mesopore range (20-500 Å) as well as macropores (>500 Å). Surface area corresponding to the matrix, i.e., the surface of pores in the range of from 20 to 10000 Å, of the equilibrium FCC catalyst typically ranges from 10 to 220 m²/g, preferably from 20 to 150 m²/g, as determined by the t-plot method. The final equilibrium FCC catalyst may have a total water pore volume of 0.2 to 0.6 cm3/g.

The FCC catalyst may comprise physical blends of catalysts and additives. Additives are used in FCC to perform a certain function, such as changing the product selectivity to favor propylene or butylene, control the combustion of coke in the regenerator or assist the refiner in meeting environmental regulations, such as SOx and NOx emissions or gasoline sulfur specification.

The additives may include a ZSM-5 based additive; an additive based on magnesium aluminate spinel, promoted by cerium oxide (CeO₂) and vanadium oxide; and/or platinum- and palladium-based additives.

The ZSM-5-based additive, such as OlefinsUltra® from W.R. Grace, is commonly used to enhance the production of propylene and butylene. The ZSM-5 additive can be blended in the range of 1 to 50 wt % of the total catalyst. The present invention is particularly beneficial for units desiring high yields of propylene and butylene.

The additive based on magnesium aluminate spinel, promoted by cerium oxide (CeO₂) and vanadium oxide, such as Super DESOX® from W.R. Grace, is commonly used to control SOx emissions. SOx additives can be blended in the range of 0.2 to 20 wt % of the total catalyst. Equilibrium catalysts from FCC units that use high levels of additive to control SOx will have CeO₂/MgO wt ratio higher than about 0.15 or show presence of crystalline Cerium oxide (CeO₂), which is detectable by a x-ray diffraction technique (XRD).

The platinum- and palladium-based additives are commonly used to aid with coke combustion in the regenerator and are typically used in <10 ppm on a Pt or Pd basis of the total catalyst.

The magnesium containing slurry may contain particles of the magnesium compound having an average particle size in a range of about 5 nm to about 1 μm, preferably about 7 nm to about 300 nm, and more preferably about 15 nm to about 150 nm. A concentration of the magnesium compound in the slurry may be in a range of about 5 wt % to about 50 wt %, preferably about 20 wt % to about 40 wt %, reported as MgO. The magnesium compound may include at least one selected from the group consisting of magnesium oxide, magnesium carbonate, magnesium hydroxide, magnesium sulfonate, magnesium acetate, and mixed metal oxides and carbonates of magnesium with aluminum or silicon. The slurry may further contain water, an organic solvent, or a mixture thereof as a liquid phase or dispersant. The organic solvent may be a carbon based substance that dissolves or disperses one or more other substances. For example, the organic solvent may be a hydrocarbon, an oxygenated hydrocarbon, an alcohol, a surfactant and combinations thereof. In one embodiment, the slurry further contains antimony or an antimony compound.

The FCC feedstock may be gas oils, either virgin or cracked. Heavier feedstocks such as vacuum resid, atmospheric resid and de-asphalted oil can also be used. While contaminated metals can be present in all the above feedstocks, they are most prevalent in the heavy streams. The FCC feedstocks are introduced as liquids, however, they vaporize when they contact hot catalyst flowing from the regenerator, the FCC cracking reaction then proceeding in the vapor phase. The metals are deposited initially on the surface of the catalyst, however, over time, some of the metals may migrate. Because the average age of the catalyst inventory in an FCC unit can be weeks or months, this means that metals will continue to accumulate on the catalyst the entire time it circulates in the unit.

Iron present in the feedstock, when deposited on catalyst, can result in dehydrogenation reactions, but more importantly, it has been found to obstruct the pores of the catalyst. When this happens, large molecules cannot diffuse into the pores of the catalyst, and so cannot be cracked. Iron compounds present in the FCC feedstock are typically present as porphyrins, naphthenates or inorganic compounds in amounts of 0 to 10000 ppm by weight (mg/kg), as Fe. Different iron-containing compounds may obstruct the pores to different degrees.

In one embodiment, a concentration of iron compounds in the iron-contaminated FCC feedstock may be in a range of about 0.5 ppm by weight to about 100 ppm by weight, preferably about 1 ppm by weight to about 50 ppm by weight, more preferably about 2 ppm by weight to about 30 ppm by weight, reported as Fe.

In the case where Fe poisoning negatively affects FCC catalyst through restriction of hydrocarbon diffusion in and out of the catalyst, a magnesium compound and a calcium compound may behave differently. It is known that the calcium compound may enhance the formation of dense iron layer on the outer surface of the FCC catalyst, thereby resulting in pore blocking (Stud. Surf. Sci. and Catal. (2003) Vol. 149, p. 139). On the contrary, addition of a small amount of a magnesium compound onto the surface of the iron-contaminated FCC catalyst unexpectedly increases the diffusivity of hydrocarbons into and out of the FCC catalyst. Without being held to a particular theory, it is very likely that the small amount of the magnesium compound on the iron-contaminated FCC catalyst may help to reduce or eliminate the dense Fe layer formation on the FCC catalyst, and preserve the diffusion of feed molecules going in and cracked molecules coming out of the FCC catalyst, thereby preserving activity and selectivity of the FCC catalyst.

In one embodiment, combining the FCC catalyst with the slurry containing the magnesium compound is performed simultaneously with combining with the iron-contaminated FCC feedstock.

In another embodiment, the slurry containing the magnesium compound may further include the iron-contaminated FCC feedstock before combining with the FCC catalyst. In this case, the slurry and the feedstock may be miscible.

In another embodiment, combining the FCC catalyst with the slurry containing the magnesium compound is performed before combining with the iron-contaminated FCC feedstock. For example, first, a slurry containing the magnesium compound, but not the calcium compound, may be prepared. Then, the FCC catalyst may be combined with the slurry, followed by combining with the iron-contaminated FCC feedstock. In this case, the slurry and the feedstock may be miscible or not miscible.

In another embodiment, combining the FCC catalyst with the slurry containing the magnesium compound is performed after combining with the iron-contaminated FCC feedstock. For example, first, a slurry containing the magnesium compound, but not the calcium compound, may be prepared. Then, the FCC catalyst may be combined with the iron-contaminated FCC feedstock, followed by combining with the slurry. In this case, the slurry and the feedstock may be miscible or not miscible. The combining of the FCC catalyst with the slurry and the iron-contaminated FCC feedstock may occur within a FCC unit.

After the combination of the FCC catalyst, the slurry, and the iron-contaminated FCC feedstock, the magnesium compound or a derivative of the magnesium compound may be deposited onto the equilibrium FCC catalyst. During the FCC process, the magnesium compound may be converted chemically or physically into the derivative of the magnesium compound, which then remains deposited on the equilibrium FCC catalyst. The magnesium compound or a derivative of the magnesium compound may be deposited on or near the outer surface of the equilibrium FCC catalyst.

In one embodiment, an amount of the magnesium compound or the derivative of the magnesium compound on the equilibrium FCC catalyst is in a range of about 100 ppm to about 30,000 ppm by weight, preferably about 300 ppm to about 20,000 ppm by weight, reported as MgO, of the equilibrium FCC catalyst.

In one embodiment, an amount of iron compounds on the equilibrium FCC catalyst is in a range of about 500 ppm to 30,000 ppm by weight, preferably about 1,000 ppm to about 20,000 ppm by weight, reported as Fe, of the equilibrium FCC catalyst.

In one embodiment, a weight ratio of the magnesium compound or the derivative of the magnesium compound, as MgO, to the iron compounds, as Fe, on the equilibrium FCC catalyst is greater than about 0.1, preferably greater than about 0.5.

In one embodiment, the equilibrium FCC catalyst has a diffusion coefficient of more than about 5 mm²/min, preferably at least about 8 mm²/min, as measured by an inverse gas chromatography technique.

An equilibrium FCC catalyst or “Ecat” is a catalyst in the inventory of the FCC unit that has been deactivated due to repeated cracking of hydrocarbon feedstock and regeneration to burn off the coke. A fresh fluid cracking catalyst is a catalyst as manufactured and sold by catalyst vendors. As the catalyst ages, it undergoes changes due to attrition, accumulation of feedstock metals and exposure to the severe hydrothermal environment of the FCC unit. The aged catalyst is characterized by loss of surface area and acid sites, which result in deterioration of activity and selectivity. During the FCC process, fresh catalyst is added, and aged catalyst is withdrawn, as needed, to maintain catalytic activity and selectivity as well as to hold proper catalyst bed levels in the FCC reactor and regenerator vessels. The equilibrium catalyst is a catalyst in the circulating inventory that reflects a balance between rates of catalyst deactivation and replacement. Hence, the Ecat includes an age distribution of fresh to severely deactivated FCC catalyst particles.

Although the slurry containing the magnesium compound does not contain a calcium compound such as CaO, there may be a small amount of calcium compounds as impurity in the FCC feedstock. Calcium may also be an impurity in the raw materials used to make the fresh catalyst. As a result, a typical equilibrium FCC catalyst may contain a small amount of calcium compounds.

Another example of the present invention is an equilibrium FCC catalyst. The equilibrium FCC catalyst may include an FCC catalyst containing calcium, and having at least one magnesium compound and iron compounds deposited on the FCC catalyst. A weight ratio of the magnesium compound, as MgO, to the iron compounds, as Fe, on the equilibrium FCC catalyst may be in a greater than 0.1. A weight ratio of calcium compounds to the magnesium compound on the equilibrium FCC catalyst, reported as CaO/MgO, may be less than about 0.25, preferably less than about 0.15.

In one embodiment, the weight ratio of the magnesium compound, as MgO, to the iron compounds, as Fe, on the equilibrium FCC catalyst is greater than 0.5. In one embodiment, an amount of the magnesium compound is in a range of about 100 ppm to about 30,000 ppm by weight, preferably about 300 ppm to about 20,000 ppm by weight, reported as MgO, of the equilibrium FCC catalyst.

The equilibrium FCC catalyst may have magnetic susceptibility in SI units of over 500×10⁻⁶, preferably over 2000×10⁻⁶.

In one embodiment, the equilibrium FCC catalyst has a diffusion coefficient greater than or equal to about 5 mm²/min. The FCC catalyst may include a faujasite and/or ZSM-5 and/or beta zeolite. The faujasite zeolite may be a Y-type zeolite.

In one embodiment, the equilibrium FCC catalyst may include a Ce-containing compound. A weight ratio of the Ce-containing compound to the magnesium compound, reported as CeO₂/MgO, in the equilibrium FCC catalyst may be less than about 0.15, preferably less than about 0.12. In one embodiment, there is absence of CeO₂ crystalline phase detectable by XRD in the equilibrium FCC catalyst.

In the description of the specification, references made to the term “one embodiment,” “some embodiments,” “example,” and “some examples” and the like are intended to refer that specific features and structures, materials or characteristics described in connection with the embodiment or example that are included in at least one embodiment or example of the present disclosure. The schematic expression of the terms does not necessarily refer to the same embodiment or example. Moreover, the specific features, structures, materials or characteristics described may be included in any suitable manner in any one or more embodiments or examples.

Hereinafter, the present invention will be described in more detail with reference to Examples. However, the scope of the present invention is not limited to the following Examples. These examples are intended for illustration purposes only and are not intended to limit the scope of the present invention.

### EXAMPLES

### Characterization Methods

Average particle size of FCC catalyst is measured according to ASTM D4464, Standard Test Method for Particle Size Distribution of Catalytic Materials by Laser Light Scattering. Particle size of MgO nanoparticles is determined by Dynamic Light Scattering, as described in ASTM E2490, Standard Guide for Measurement of Particle Size Distribution of Nanomaterials in Suspension by Photon Correlation Spectroscopy (PCS). Chemical composition or elemental analysis is performed by an inductively coupled plasma (ICP) technique. Surface Area is determined according to ASTM D3663-03(2015), Standard Test Method for Surface Area of Catalysts and Catalyst Carriers. Zeolite surface area and matrix surface area are determined according to ASTM D4365-19, Standard Test Method for Determining Micropore Volume and Zeolite Area of a Catalyst. Unit Cell Size is determined according to ASTM D3942-03(2013), the standard Test Method for Determination of the Unit Cell Dimension of a Faujasite-Type. Zeolite. Cracking reaction was carried out in an Advanced Cracking Evaluations (ACE™) fixed fluid bed reactor at 1004° F., using a resid feedstock with a 30 second feed injection time. Catalyst dosage was varied to obtain a range of conversion at catalyst to oil ratios of 4.5, 6 and 8. Elemental mapping was conducted on a JEOL JXA-8230 Electron Probe Microanalyzer, equipped with both an Energy Dispersive Spectrometer (EDS) and a Wavelength Dispersive Spectrometer (WDS). For imaging and mapping particle cross section, particles were placed in an epoxy, and the resin was cured overnight at room temperature. The sample stub was then cut with a diamond blade, and polished to a smooth surface.

The determination of Grace Effective Diffusion Coefficient (GeDC) is based on the principle of inverse gas chromatography and is carried out on an Agilent HP 7890 GC, configured by PAC Analytical Controls. For each test, a quartz glass column of 12 cm length and 2 mm ID is packed with 100 mg of catalyst. The probe molecule, 1,2,4-Trimethylcyclohexane is prepared as a 5 wt % solution in carbon disulfide. Nitrogen is used as carrier gas. For each sample, the GC runs were conducted at seven carrier flow settings, between 70 to 99 mL/min. At each carrier flow rate, a methane pulse is used for dead time determination. The chromatograms are analyzed by the van Deemter Equation to determine the GeDC, as described in the US Patent Application No. 2017/0267934 A1.

The magnetic susceptibility of the samples was measured with a Bartington MS3 meter in combination with the MS2B sensor operated in a HF/LF mode. A minimum of 17 g of the sample was filled into a 20 mL HDPE vial. Before each measurement, a blank was measured for 5 s before the sample was placed in the meter and measured for 10 s. All results are reported in SI units.

### Comparative Examples 1 & 2

An equilibrium FCC catalyst (Ecat), as Comparative Example 1, is taken from a commercial FCC unit with a Grace effective diffusion coefficient (GeDC) of 13 mm²/min. The equilibrium FCC catalyst was deactivated in a fluidized-bed laboratory reactor using the Cyclic Propylene Steam (CPS) deactivation protocol for 40 hours, 60 cycles at 1350° F. to obtain a deactivated equilibrium FCC catalyst, as Comparative Example 2. The CPS deactivation procedure has been described in Wallenstein et. al., Appl. Catal. A., Vol. 204, 89-106 (2000). GeDC of the deactivated equilibrium FCC catalyst decreased to 7 mm²/min, as shown in Table 1.

### Comparative Example 3

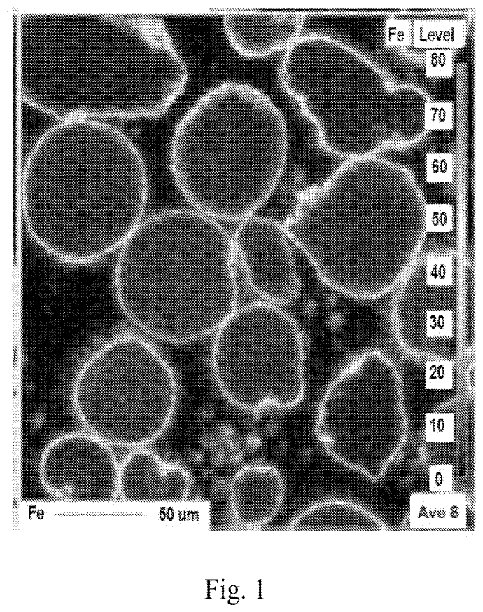

An aliquot of the equilibrium FCC catalyst as Comparative Example 1 was spray coated with 7000 ppmw of Fe using nanoparticles of the iron compounds, Iron(III) oxyhydroxide, suspended in an aqueous solution, followed by the same CPS deactivation in Comparative Example 2 to obtain a deactivated equilibrium FCC catalyst coated with only iron compounds, as Comparative Example 3. The procedure for spray coating has been described in Wallenstein et. al., Appl. Catal. A., Vol. 462-463, 91-99 (2013). The electron probe micro-analyzer (EPMA) analysis shows that nanoparticles of the iron compounds are deposited mainly on an outer surface of equilibrium FCC catalyst particles and formed a thin shell surrounding the equilibrium FCC catalyst particles, as shown in FIG. 1. GeDC of the resulted deactivated equilibrium FCC catalyst coated with only iron compounds decreased to 3 mm²/min, as shown in Table 1. The magnetic susceptibility of the resulted deactivated equilibrium FCC catalyst coated with only iron compounds increased with the addition of iron compounds by more than an order of magnitude, as shown in Table 1. Both the decrease in GeDC and the increase in magnetic susceptibility are consistent with observations in commercial FCC units experiencing Fe poisoning.

### Example 1

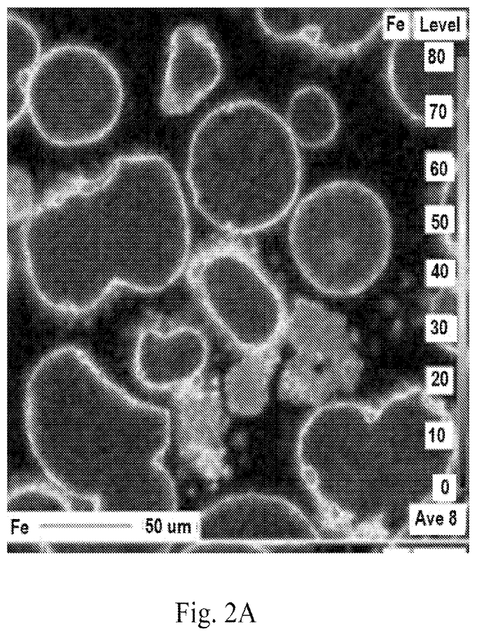

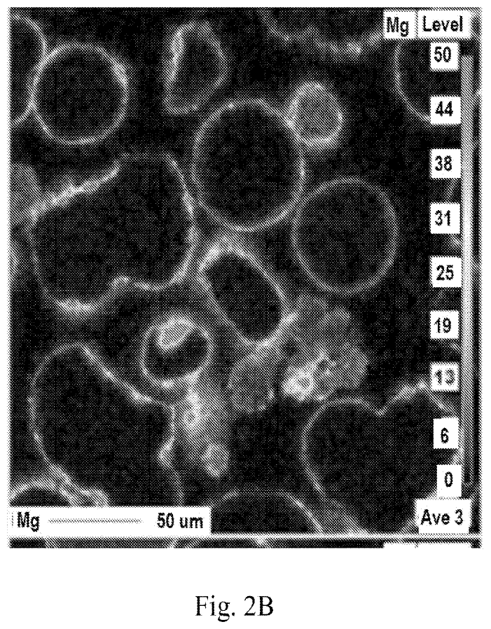

Another aliquot of the equilibrium FCC catalyst as Comparative Example 1 was spray coated with 7000 ppmw of Fe using nanoparticles of the iron compounds, Iron(III) oxyhydroxide, suspended in an aqueous solution, and 17000 ppmw of MgO using nanoparticles of MgO/Mg(OH)₂ suspended in an aqueous solution, followed by the same CPS deactivation as Comparative Example 2 to obtain a deactivated equilibrium FCC catalyst coated with iron compounds and a magnesium compound, as Example 1. GeDC of the resulted deactivated equilibrium FCC catalyst coated with iron compounds and the magnesium compound only decreased to 10 mm²/min, as shown in Table 1. EPMA analysis shows that nanoparticles of iron compounds and MgO/Mg(OH)₂ are mainly deposited on the outer surface of the equilibrium FCC catalyst particles and formed a thin shell surrounding the equilibrium FCC catalyst particles, as shown in FIGS. 2A and 2B respectively.

TABLE 1
Comparison of properties of equilibrium FCC catalysts:

| | Comp. Exam. 1 | | Comp. Exam. 3 | Exam. 1 |
|---|---|---|---|---|
| | As Received | Comp. Exam. 2 | Deactivated Ecat | Deactivated Ecat |
| | Ecat | Deactivated Ecat | with Fe Only | with Fe & Mg |
| Al₂O₃, wt % | 58.8 | 58.6 | 57.3 | 57.3 |
| CaO, ppmw | 1000 | 1000 | 1000 | 1100 |
| Fe, ppmw | 5400 | 5100 | 11900 | 11200 |
| MgO, ppmw | 200 | 400 | 400 | 16800 |
| Na₂O, wt % | 0.32 | 0.29 | 0.30 | 0.32 |
| RE₂O₃, wt % | 2.02 | 1.91 | 1.92 | 1.87 |
| Sb, ppmw | 562 | 618 | 616 | 586 |
| Ni, ppmw | 1785 | 1532 | 1557 | 1454 |
| V, ppmw | 3270 | 3130 | 3180 | 3000 |
| GeDC, mm²/min | 13 | 7 | 3 | 10 |
| Magnetic | 292 | 185 | 3028 | 2782 |
| Susceptibility | | | | |
| (SI) × 10⁻⁶ | | | | |
| MgO/Fe | 0.04 | 0.07 | 0.04 | 1.50 |
| CaO/MgO | 5.00 | 2.75 | 2.40 | 0.06 |

As shown in Table I, the analysis results show that for the Ecat with added Fe as in Comparative Example 3, GeDC decreased much more than those without added Fe as in Comparative Example 2. In contrast, for the Ecat with added Fe and added Mg as in Example 1, GeDC decreased much less than that with added Fe alone as in Comparative Example 3 and that without any treatment as in Comparative Example 2. These results demonstrate that addition of a small amount of a magnesium compound such as MgO to the external surface of the equilibrium FCC catalyst helps to alleviate the negative impact of added Fe on the diffusivity of hydrocarbons in and out of the catalyst, thereby significantly reducing the iron poisoning of the catalyst.

The three deactivated Ecat samples, Comparative Examples 2 & 3 and Example 1, were tested by ACE using a feedstock with properties shown in Table 2.

TABLE 2
Properties of FCC feedstock

| | | |
|---|---|---|
| API | | 21.66 |
| Specific Gravity | | 0.9239 |
| K Factor | | 12.06 |
| Refractive Index | | 1.516 |
| Sulfur | wt % | 0.546 |
| Basic Nitrogen | wt % | 0.036 |
| Total Nitrogen | wt % | 0.12 |
| Conradson Carbon | wt % | 4.75 |
| Distillation, Initial | ° F. | 338 |
| Boiling Pt | | |
| Distillation, 10% | ° F. | 751 |
| Distillation, 30% | ° F. | 854 |
| Distillation, 50% | ° F. | 944 |
| Distillation, 70% | ° F. | 1057 |
| Distillation, 90% | ° F. | 1242 |
| Distillation, 95% | ° F. | 1320 |

TABLE 3
ACE yields at 80 wt % conversion

| | | Comp. Exam. 3 | Exam. 1 |
|---|---|---|---|
| | Comp. Exam. 2 | Deactivated Ecat | Deactivated Ecat |
| | Deactivated Ecat | with Fe Only | with Fe & Mg |
| Catalyst to Oil | 6.3 | 6.7 | 6.3 |
| Ratio | | | |
| Hydrogen, wt % | 0.37 | 0.32 | 0.37 |
| Tot C1 + C2, wt % | 2.2 | 2.4 | 2.2 |
| Dry Gas, wt % | 2.6 | 2.7 | 2.5 |
| Propylene, wt % | 5.6 | 5.6 | 5.9 |
| Total C3s, wt % | 6.7 | 6.8 | 6.9 |
| IsoButane, wt % | 3.9 | 4.3 | 4.0 |
| Isobutylene, wt % | 1.9 | 1.8 | 2.0 |
| iC4/iC4= | 2.0 | 2.5 | 2.0 |
| Total C4 = s, wt % | 6.9 | 6.5 | 7.2 |
| Total C4s, wt % | 11.7 | 11.9 | 12.1 |
| Gasoline, wt % | 50.2 | 49.4 | 49.6 |
| LCO, wt % | 15.3 | 15.0 | 15.2 |
| Bottoms, wt % | 4.7 | 5.0 | 4.8 |
| Coke, wt % | 8.8 | 9.2 | 8.9 |
| Gasoline Olefins, wt % | 23.8 | 21.6 | 23.7 |
| RON | 92.6 | 92.3 | 92.7 |
| MON | 81.1 | 81.3 | 81.2 |

The results are listed in Table 3. Compared to the deactivated Ecat (Comparative Example 2) at constant conversion of 80 wt %, the deactivated Ecat with added Fe only (Comparative Example 3) has lower activity, as evidenced by the higher catalyst to oil ratio required to achieve equal conversion, higher coke and higher bottoms yields. The Fe only catalyst (Comparative Example 3) also has higher tendency toward saturating olefins, as evidence by the higher hydrogen transfer index (defined as the ratio of isobutane/isobutene), lower C4 olefins, lower gasoline olefins and lower octane. The activity and selectivity differences observed in the ACE testing are consistent with activity and selectivity differences commonly observed in commercial FCC units where catalyst inventory is poisoned by Fe.

In contrast, compared to the deactivated Ecat with added Fe only (Comparative Example 3), the deactivated Ecat with added Fe and Mg (Example 1) has unexpectedly higher activity, as evidenced by the lower catalyst to oil ratio required to achieve equal conversion, lower coke and lower bottoms yields. The catalyst with added Fe and Mg (Example 1) has lower hydrogen transfer index and higher C4 olefins, higher gasoline olefins and higher octane. These results demonstrate that the Fe poisoning effect have been unexpectedly reduced or eliminated by the addition of MgO.

### Comparative Examples 4-6

The following Examples and Comparative Examples demonstrate the superiority of MgO over CaO in reducing the loss of diffusivity due to Fe poisoning. An aliquot of the same Ecat from Comparative Example 1 was spray coated with nanoparticles of iron compounds, Iron(III) oxyhydroxide, (Comparative Example 4). New aliquots of the same Ecat from Comparative Example 1 were spray coated with nanoparticles of iron compounds, Iron(III) oxyhydroxide, followed by two levels (11400 and 20200 ppmw as CaO, as Comparative Examples 5 & 6 respectively) of CaO, using a calcium nitrate solution. The metal-impregnated samples were deactivated in a fluidized bed reactor using CPS deactivation protocol, as described in Comparative Example 2.

### Examples 2 & 3

New aliquots of the same Ecat from Comparative Example 1 were spray coated with nanoparticles of iron compounds, Iron(III) oxyhydroxide, followed by two levels (7300 and 16200 ppmw as MgO, as Examples 2 & 3 respectively) of the MgO/Mg(OH)₂ suspension described in Example 1, and the metals-impregnated samples were deactivated in a fluidized bed reactor using CPS deactivation protocol, as described in Comparative Example 2.

GeDC, magnetic susceptibility and chemical analysis of the 6 CPS deactivated Ecat samples are listed in Table 4. The results show that the magnetic susceptibility increases for all samples with added Fe. The GeDC decreases for the sample with only added Fe, as in Comparative Example 4. With addition of Fe and MgO in Examples 2 and 3, the GeDC is about the same as the deactivated Ecat without added Fe and much higher than the sample with added Fe only. For comparison, the GeDC values of samples spray coated with Fe and CaO were about the same as that of the Fe only sample. The results again demonstrate that addition of MgO to the external surface of the FCC catalyst helps to alleviate the negative impact of added Fe in limiting diffusion of hydrocarbons in and out of the catalyst. However, the addition of a calcium compound provides no benefit to improving the diffusivity of Fe-poisoned catalyst.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

TABLE 4
Properties of Ecats before and after spray-coating with iron and magnesium or calcium, followed by CPS deactivation.

| | | Comp. Exam. 4 | Exam. 2 | Exam. 3 | Comp. Exam. 5 | Comp. Exam. 6 |
|---|---|---|---|---|---|---|
| | Comp. Exam. 2 | Deactivated Ecat | Deactivated Ecat | Deactivated Ecat | Deactivated Ecat | Deactivated Ecat |
| | Deactivated Ecat | with Fe Only | with Fe & Mg #1 | with Fe & Mg #2 | with Fe & Ca #1 | with Fe & Ca #2 |
| Al₂O₃, wt % | 58.1 | 57.9 | 56.6 | 58.1 | 60.2 | 55.9 |
| CaO, ppmw | 1000 | 1000 | 1000 | 1000 | 20200 | 11400 |
| Fe, ppmw | 5400 | 11300 | 11700 | 11500 | 11500 | 11200 |
| MgO, ppmw | 500 | 400 | 16200 | 7300 | 400 | 400 |
| Na₂O, wt % | 0.32 | 0.30 | 0.33 | 0.31 | 0.32 | 0.30 |
| RE₂O₃, wt % | 1.94 | 1.92 | 1.89 | 1.90 | 1.99 | 1.96 |
| Sb, ppmw | 591 | 584 | 567 | 590 | 619 | 586 |
| Ni, ppmw | 1634 | 1493 | 1555 | 1496 | 1609 | 1451 |
| V, ppmw | 3360 | 3140 | 3250 | 3130 | 3260 | 3050 |
| GeDC, mm²/min | 7 | 2 | 7 | 6 | 2 | 2 |
| Magnetic Susceptibility | 167 | 3426 | 1866 | 2943 | 4291 | 3522 |
| (SI) × 10⁻⁶ | | | | | | |
| MgO/Fe | 0.08 | 0.04 | 1.38 | 0.64 | 0.04 | 0.04 |
| CaO/MgO | 2.16 | 2.37 | 0.06 | 0.14 | 47.07 | 28.43 |

1. A process for catalytic cracking of an iron-contaminated fluid catalytic cracking (FCC) feedstock, the process comprising:
combining a FCC catalyst, a slurry comprising a magnesium compound, and an iron-contaminated FCC feedstock during a FCC process under fluid catalytic cracking conditions, thereby generating an equilibrium FCC catalyst with reduced iron poisoning,
wherein the slurry comprising the magnesium compound does not contain a calcium compound.

2. The process of claim 1, wherein combining the FCC catalyst with the slurry comprising the magnesium compound is performed simultaneously with combining with the iron-contaminated FCC feedstock.

3. The process of claim 1, wherein combining the FCC catalyst with the slurry comprising the magnesium compound is performed before or after combining with the iron-contaminated FCC feedstock.

4. The process of claim 1, wherein the slurry comprises particles of the magnesium compound having an average particle size about 5 nm to about 1 μm.

5-6. (canceled)

7. The process of claim 1, wherein a concentration of the magnesium compound in the slurry is from in a range of about 5 wt % to about 50 wt %, reported as MgO.

8. (canceled)

9. The process of claim 1, wherein a concentration of iron compounds in the iron-contaminated FCC feedstock is from about 0.5 ppm by weight to about 100 ppm by weight, reported as Fe.

10-11. (canceled)

12. The process of claim 1, wherein the magnesium compound comprises at least one selected from the group consisting of magnesium oxide, magnesium carbonate, magnesium hydroxide, magnesium sulfonate, magnesium acetate, and mixed metal oxides and carbonates of magnesium with aluminum or silicon.

13. The process of claim 1, wherein the slurry comprises water, an organic solvent or a mixture thereof as a liquid phase or dispersant.

14. The process of claim 1, wherein the magnesium compound or a derivative of the magnesium compound is deposited on the equilibrium FCC catalyst after the combining.

15. The process of claim 14, wherein an amount of the magnesium compound or the derivative of the magnesium compound on the equilibrium FCC catalyst is from about 100 ppm to about 30,000 ppm by weight, reported as MgO, of the equilibrium FCC catalyst.

16. (canceled)

17. The process of claim 14, wherein an amount of iron compounds on the equilibrium FCC catalyst is from about 500 ppm to 30,000 ppm by weight, reported as Fe, of the equilibrium FCC catalyst.

18. (canceled)

19. The process of claim 17, wherein a weight ratio of the magnesium compound or the derivative of the magnesium compound, as MgO, to the iron compounds, as Fe, on the equilibrium FCC catalyst is greater than about 0.1.

20. (canceled)

21. The process of claim 19, wherein the equilibrium FCC catalyst has a diffusion coefficient of more than about 5 mm²/min, as measured by an inverse gas chromatography technique.

22. (canceled)

23. The process of claim 1, wherein the slurry further comprises antimony or an antimony compound.

24. (canceled)

25. An equilibrium FCC catalyst, comprising:
an FCC catalyst containing calcium, and having at least one magnesium compound and iron compounds deposited on the FCC catalyst,
wherein a weight ratio of the magnesium compound, as MgO, to the iron compounds, as Fe, on the equilibrium FCC catalyst is greater than about 0.1, and a weight ratio of calcium compounds to the magnesium compound on the equilibrium FCC catalyst, reported as CaO/MgO, is less than about 0.25.

26. The equilibrium FCC catalyst of claim 25, wherein the weight ratio of the magnesium compound, as MgO, to the iron compounds, as Fe, on the equilibrium FCC catalyst is greater than about 0.5.

27-31. (canceled)

32. The equilibrium FCC catalyst of claim 25, wherein the FCC catalyst comprises a faujasite and/or ZSM-5 and/or beta zeolite.

33. The equilibrium FCC catalyst of claim 32, wherein the faujasite zeolite is a Y-type zeolite.

34. The equilibrium FCC catalyst of claim 25, wherein the weight ratio of calcium compounds to the magnesium compound on the FCC catalyst, reported as CaO/MgO, is less than about 0.15.

35-36. (canceled)

37. The equilibrium FCC catalyst of claim 25, wherein a weight ratio of a Ce-containing compound to the magnesium compound, reported as CeO₂/MgO, in the equilibrium FCC catalyst is less than about 0.15.

38. (canceled)
